(19) United States
(12) Patent Application Publication
(10) Pub. No.: US 2008/0105469 A1
(43) Pub. Date: May 8, 2008

(54) Battery powered mobility scale with wireless display

(76) Inventor: Douglas R. Domel, Santa Clarita, CA (US)

Correspondence Address: ROGITZ & ASSOCIATES, 750 B STREET, SUITE 3120, SAN DIEGO, CA, 92101, US

(21) Appl. No.: 11/591,920

(22) Filed: Nov. 2, 2006

(51) Int. Cl. G01G 19/34; G01G 23/18

(52) U.S. Cl. 177/25.12; 177/45

(57) ABSTRACT

A scale has a base with strain gages to sense the weight of a user positioned on the base. A battery-powered processing system receives signals from the base and, through a wireless transmitter, sends the signals to a wall-mounted display that displays the user's weight.

### FIELD OF THE INVENTION

The present invention relates generally to scales with wireless weight displays.

### BACKGROUND OF THE INVENTION

It is frequently necessary for medical patients, many of whom may be debilitated, to weigh themselves. For example, a patient in a wheelchair may be required to weigh himself, as might an obese person and a person with poor eyesight. In each case, the present invention critically recognizes that it can be problematic for the user to see the weight display, which typically is provided on the scale at foot level.

As further recognized herein, to the extent that special purpose scales have been provided, they tend to be expensive, heavy, and in general relatively immobile. The present invention critically recognizes that it is possible to provide a lightweight, inexpensive scale with an easily viewable weight display that can be used by a wide variety of users.

### SUMMARY OF THE INVENTION

A scale system is disclosed that includes a base and one or more weight sensors on the base to sense the weight of an object positioned on the base and to generate signals representative thereof. A processor can be on the base for receiving signals from the weight sensors and in response generating a weight signal. A wireless transmitter on the base receives the weight signal from the processor and wirelessly transmits it. In exemplary implementations a non-AC power source such as a Lithium battery is on the base and is the sole source of power for the processor and transmitter. The weight signal from the transmitter is received by a wireless receiver on a display module that is distanced from the base, and the display module includes an audible or visual display configured for displaying a weight.

With the above structure, the base can be positioned on a horizontal floor and the display module can be mounted on a vertical wall adjacent the base for convenient viewing of the weight.

The transmitter and receiver may use any form of wireless communication such as but not limited to electromagnetic (RF) or electrostatic radiation, sound waves, either audible or ultrasonic, or light waves, such as visible, infrared (IR), or ultraviolet (UV). The weight sensor may be, e.g., a strain gage. In some implementations two strain gages can be provided with the distance between gages being equal to the distance between two wheels of a wheelchair. In this latter non-limiting implementation the base can be formed with first and second co-parallel spaced-apart wheel channels, with the first strain gage being positioned just below the first channel and with the second strain gage being positioned just below the second channel.

In preferred non-limiting implementations the base is established by at least one pad defining a mat for supporting a wheel. The mat is bounded by opposed raised rails. Each rail is supported on the ground solely by opposed footings, with each footing being coupled to a weight sensor in the rail by a respective bar. The two bars of a rail can be held together on the weight sensor. The pad may be configured to support one and only one wheel, or it may be configured to support two tandem wheels, or yet again it may be configured to support two side-by-side wheels.

In another aspect, a scale system includes a base on which an object to be weighed can be positioned, and means on the base for sensing a weight of the object. The system further includes means on the base for wirelessly transmitting a signal representative of the weight. As set forth further below, a display module is distanced from the base, and the display module supports means for receiving the signal representative of the weight. Means are on the display module for displaying the weight.

In yet another aspect, a method for weighing a user includes providing a base on a floor, and mounting a display module on a wall above the floor. The method also includes generating a signal representative of a user's weight when the user stands on the base, wirelessly communicating a signal representative of the weight to the display module, and displaying the weight on the display module.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of one implementation of the present scale system, with portions in the base shown in phantom;

FIG. 2 is a perspective view of an alternate embodiment showing a pad configured to support a single wheel of a three- or -four-wheeled chair;

FIG. 3 is a perspective view showing two pads of FIG. 2 with wheels placed on each for illustration;

FIG. 4 is a perspective view of another alternate embodiment showing two elongated pads, each configured to support two tandem wheels of a four-wheeled chair;

FIG. 5 is a perspective view of yet another alternate embodiment showing a wide pad assembly with two side-by-side pads in an integrated pad base for supporting coaxial wheels of a chair;

FIG. 6 is a front elevational view of the pad shown in FIG. 2;

FIG. 7 is a perspective view from the bottom of the pad shown in FIG. 2; and

FIG. 8 is a perspective view of the internal weight measuring structure of a pad, with the plastic pad body removed for clarity.

### DETAILED DESCRIPTION OF THE PREFERRED EMBODIMENT

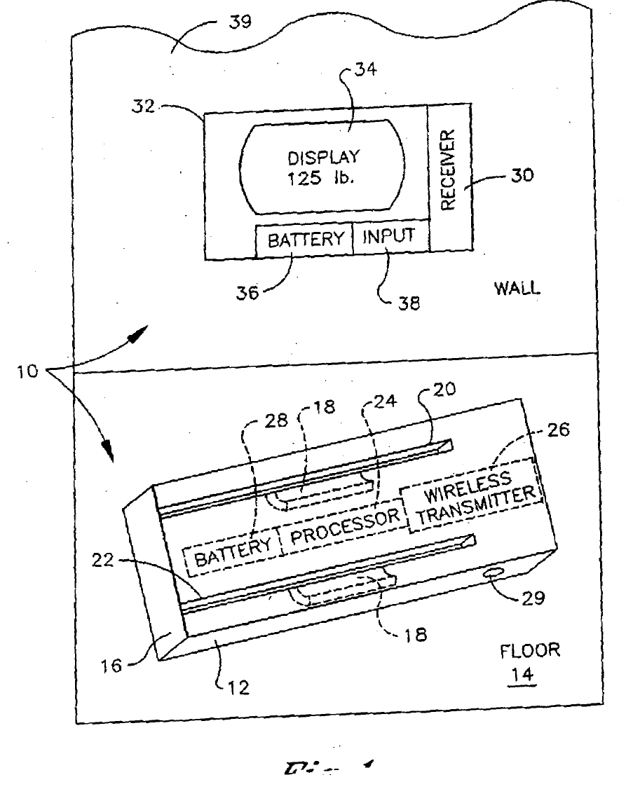

Referring to FIG. 1 for an understanding of one non-limiting implementation of a scale system 10, a lightweight (e.g., plastic) base 12 can be placed on a horizontal floor 14 to support an object such as a human user, potentially in a wheelchair. In other embodiments present principles can be used to weigh, e.g., a vehicle that can be wheeled onto the base. If desired, one end of the base 12 can be formed with a ramp 16 as shown to facilitate driving a wheeled object onto the base 12. While the non-limiting base 12 shown in FIG. 1 is a single unitary structure onto which a wheelchair can be rolled with all four wheels positioned on the base simultaneously, alternate embodiments disclosed below show other base configurations.

At least one weight sensor 18 is mounted on the base 12. The weight sensor may be a strain gage or other sensor. In the embodiment shown in the non-limiting embodiment of FIG. 1, which contemplates weighing a wheelchair-bound patient, two weight sensors 18 are provided as shown, one sensor 18 beneath a first channel 20 and one sensor 18 beneath a second channel 22. The channels 20, 22 are elongated and are parallel to each other as shown, extending substantially from the ramp 16 toward the opposite end of the base and spaced apart from each other by the distance between wheels of a wheelchair, e.g., by nineteen inches. In other embodiments only a single weight sensor might be provided, and in still other embodiments more than two weight sensors may be provided. For instance, if the object to be weighed is a vehicle, four weight sensors might be provided, one each beneath the expected approximate locations of the wheels of the vehicle when it is properly positioned on the base.

Accordingly, the skilled artisan can appreciate that when an object such as a patient in a wheelchair is positioned on the base 12, the weight sensor or sensors 18 generate signals representative of the patient's weight. These signals are sent to a processing system 24. The processing system 24 may include a digital processing apparatus as well as appropriate signal conditioning circuitry for conditioning raw signals from the sensor 18 to signals appropriate for digital processing. Likewise, the processing system 24 may include output circuitry appropriate for conditioning the signal generated by a digital processing apparatus to signals suitable for transmission by a transmitter 26. The processing system 24 can be activated by signals from the sensors 18, indicating an object to be weighed is on the scale, or by signals from a separate switch in the base that generates a signal indicating that a measurable object is on the scale.

In accordance with principles known in the art, the processing system 24 generates a signal representing the patient's weight. It can do this by, e.g., adding the weights indicated by the signals from the weight sensors 18, and subtracting the weight of a wheelchair. The weight of a wheelchair may be assumed by the processing system 24 or it may be input by a person as set forth further below, or the wheelchair may be weighed without the patient, and this weight automatically stored as the tare weight. Also, the processing system 24 preferably allows any oscillations in the signals from the weight sensors 18 to dampen out below a threshold before outputting a weight signal.

With specific regard to the transmitter 26, it receives the output of the processing system 24 and generates a wireless signal representative thereof. In any case, both the processing system 24 and transmitter 26 can use, as their sole source of power, a non-ac power source such as one or more batteries 28 in the base 12, e.g., one or more alkaline or Lithium batteries. In other embodiments the non-ac source of power can be a batteryless direct current power supply system consisting of a fuel cell, or a system that includes a solar cell-charged capacitor that powers the processing system and transmitter without the need for any other source of power. Such a system is disclosed in U.S. Pat. No. 6,812,662, incorporated herein by reference.

If desired, an on-off switch 29 can be provided on the base 12. The switch 29 can be used to deenergize the electrical components discussed above, i.e., to disconnect the battery 28 or other power supply from the processing system 24 and transmitter 26, to facilitate moving the base 12.

As shown in the Figure, the wireless transmitter 26 wirelessly sends the weight signal to a wireless receiver 30 of a display module 32 that can be mounted on a vertical wall 39 next to the base 12 but otherwise unconnected to the base 12. The receiver 30 may include circuitry including a digital processor for rendering the signal appropriate for display on a display 34. The display 34 may be a visual display as shown that displays a numeric indication of weight, or it may be an audio display that outputs an audible weight using, e.g., a computerized voice system. As was the case with the base 12, in non-limiting embodiments the electrical components in the display module 32 may use, as their sole source of power, one or more non-ac power sources such as a battery 36, although in other implementations the display module 32 may be powered off the ac power grid. If desired, the display module 32 may also include an input device 38 such as a keypad or voice recognition device that a person can use to, e.g., input the weight of a wheelchair for purposes discussed above. Alternatively, the input device 38 may be provided on the base 12.

The wireless communication between transmitter 26 and receiver 30 may be infrared (IR) and may use the system described in U.S. Pat. No. 6,060,854, incorporated by reference, wherein the transmitter of the system in the '854 patent is not located in a hand-held remote control but rather is located as shown for the transmitter 26 in the base 12 of the Figure. Or, the wireless communication between transmitter 26 and receiver 30 may be radiofrequency (RF) and may use the system described in U.S. Patent Publication No. 2005/0215210, incorporated by reference, wherein the transmitter of the system in the '210 patent publication is not located in a hand-held remote control but rather is located as shown for the transmitter 26 in the base 12 of the Figure. In either case, the systems disclosed in the referenced documents advantageously consume very little power, thus lengthening the life of the batteries discussed herein. Alternatively, the communication between the transmitter 26 and receiver 30 may be an ultrasonic signal, or any other means of wired or more preferably wireless communication.

With the above description in mind, a user can be positioned on the base 12 by, e.g., standing on the base or by being wheeled onto the base. The consequent signals generated by the weight sensor or sensors 18 are processed by the processing system 24 into a signal representing the weight of the user, preferably accounting for the weight of the wheelchair as discussed above. The weight signal is wirelessly transmitted by the transmitter 26 to the receiver 30 and a display of the signal is presented on the display 34 of the display module 32, which is conveniently mounted on the wall preferably near eye-height of the user so that the user, who might be in a wheelchair or who might be obese or possess poor vision can more easily discern the weight. The display module alternatively may be mounted on a table, bench, or even on the wheelchair itself. Less advantageously, a wired connection between the base 12 and display module 32 may be used in lieu of the wireless communication system disclosed herein.

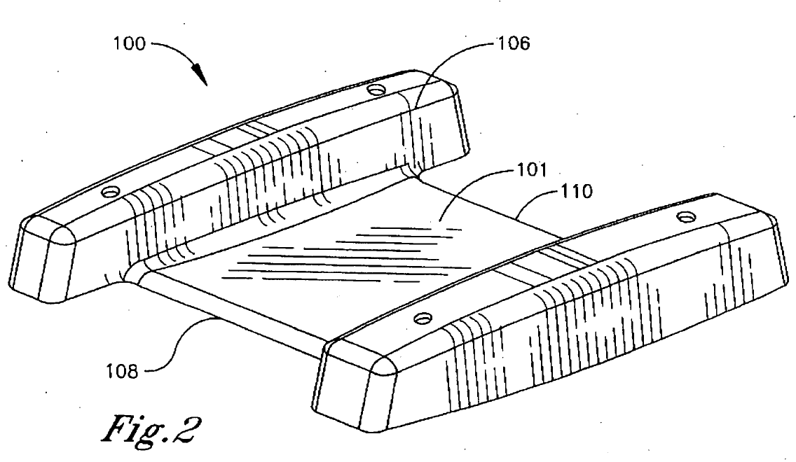

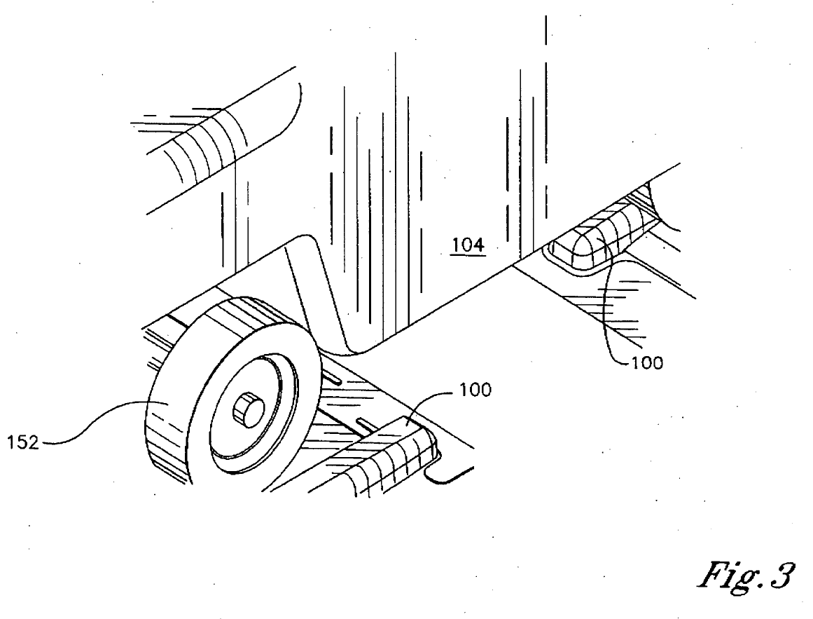

Turning now to FIGS. 2-6 for alternate embodiments and focusing first on FIGS. 2 and 3, a pad 100, which could have a unitary plastic body made of, e.g., polyurethane, has a mat portion 101 sized and configured to support a single wheel 102 (FIG. 3) of a three- or four-wheel chair 104. As set forth further below, the pad 100 has internal structure for sensing weight and transmitting weight signals to, e.g., the receiver 30 shown in FIG. 1.

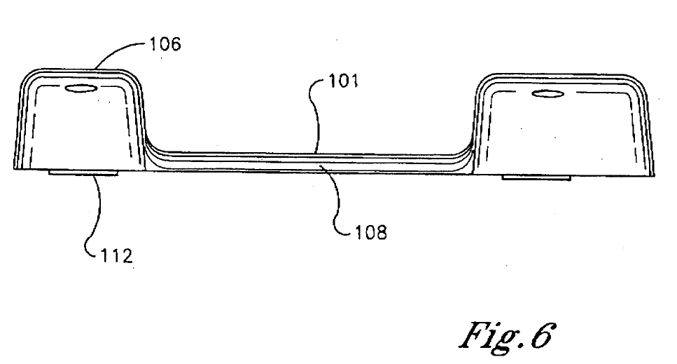

The mat portion 101 is bounded by opposed raised rails 106 which straddle the wheel 102 to prevent the chair 104 from being rolled off the mat portion 101 except along sloped front and rear ramps 108, 110. Each rail 106 has two footings, shown and described further below in reference to FIG. 6, one located near one end of the rail 106 adjacent the front ramp 108 and one footing located near the other end of the rail 106 adjacent the rear ramp 110. Thus, the pad 100 has four total footings in the preferred non-limiting implementation shown in FIGS. 2 and 3. When the pad 100 is placed on the ground, the only portion of the pad 100 that touches the ground are the four corner footings; thus, the edges of the ramps 108, 110, while very close to the ground to facilitate ease of rolling a chair onto the pad 100, are nonetheless slightly spaced from the ground by, e.g., a few millimeters. All weight on the pad 100 thus is transferred to the four corner footings.

It may readily be appreciated that four pads 100 can be arranged on the ground as appropriate for rolling respective wheels of a four-wheeled chair onto respective pads. Or, three pads 100 can be arranged on the ground as appropriate for rolling respective wheels of a three-wheeled chair onto respective pads. In this way, both types of chairs can be weighed. A user may be permitted to enter (using, e.g., the input device 38 shown in FIG. 1) the number of pads being used so that the weight determination circuitry can multiply the signal from a single pad by the appropriate amount (three or four). In such an embodiment, only one pad 100 need contain the weight sensing structure disclosed below, with its signal being multiplied by three or four and with the remaining pads being “dummy” pads devoid of weight sensors. Or, each pad 100 may contain weight sensing structure and each may transmit its weight signals on a respective frequency or use other means to discriminate its signals from those of the other pads, so that the (three or four) separate and distinct signals received at the display unit can be simply added together without requiring the user to enter the number of pads being used.

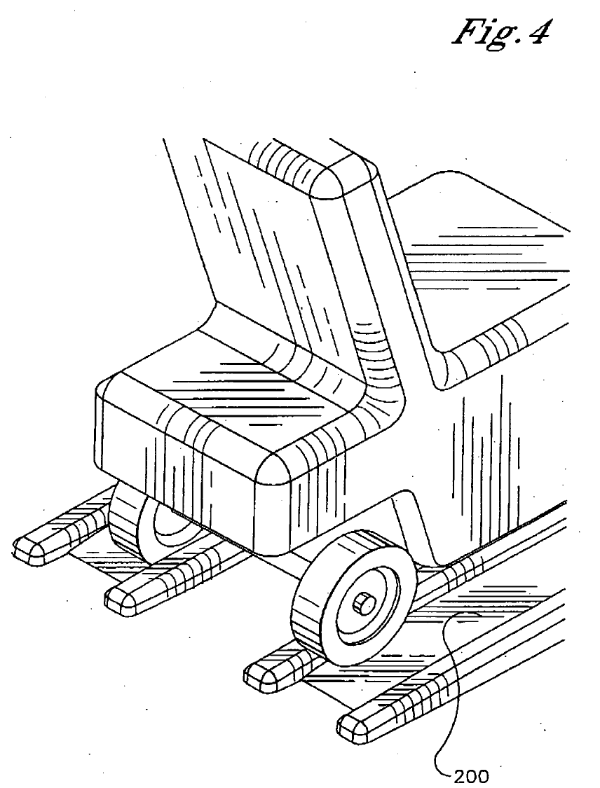

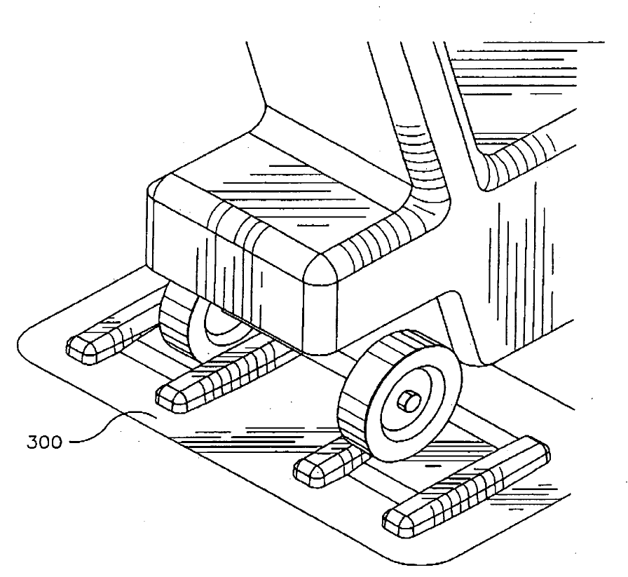

FIG. 4 shows that alternatively to a pad 100 that bears one and only one wheel and is physically separate from other pads, a pad 200 might be elongated sufficiently to simultaneously bear two wheels in tandem of a chair. Like the pad 100, the pad 200 shown in FIG. 4 has four footings, one at each end of the rails of the pad. Yet again, FIG. 5 shows that a pad assembly 300 may integrate two of the pads 100 shown in FIG. 2 in a single structure in a side-by-side arrangement, for supporting the front (or rear) wheels of a chair.

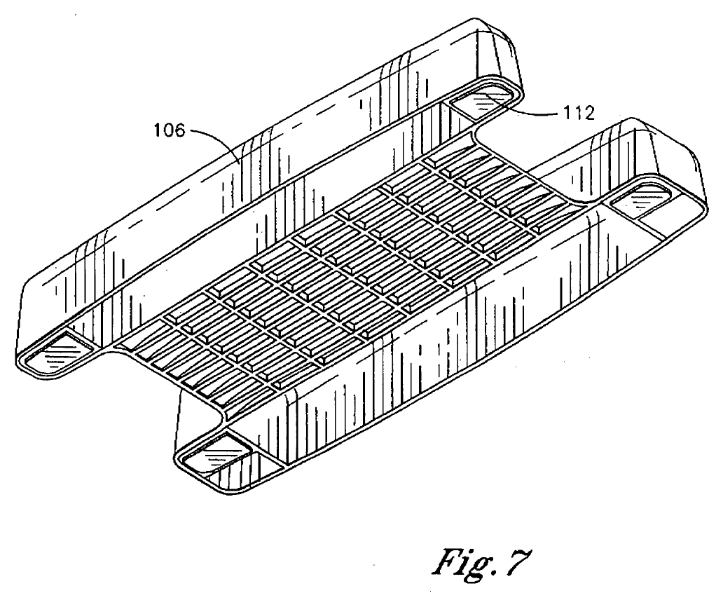

FIGS. 6 and 7 show the four footings 112 of the pad 100. As shown best in FIG. 6, each footing 112 extends slightly below the remaining (non-footing) structure of the pad, so that all weight on the pad is borne by the footings. Each footing 112 is located near an end of a rail 106 and is disposed either slightly in front of the front edge of the front ramp 108 or slightly behind the rear edge of the rear ramp 110, it being understood that the particular disposition is exemplary only. As shown in FIG. 7, the bottom part of the unitary plastic body of the pad, which may be injection molded, may be honeycombed for strength.

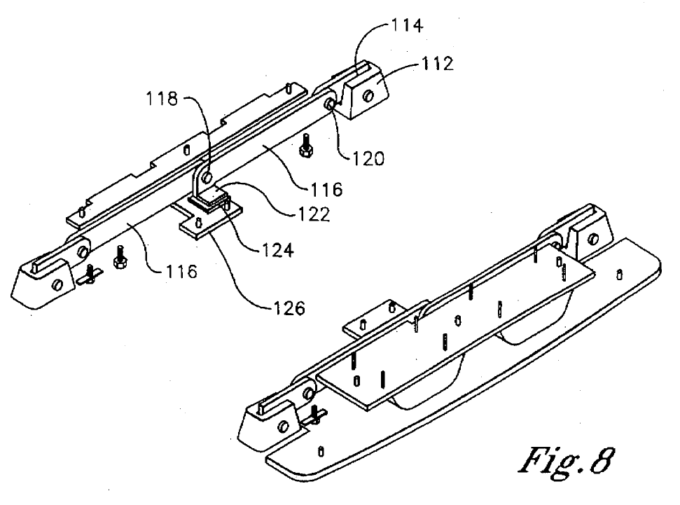

Now referring to FIG. 8 for an understanding of the weight sensing structure in each rail 106, the top of each footing 112 is formed with a groove 114 that receives a part of an elongated bar 116. As can be appreciated in reference to FIG. 8, each bar 116 is oriented horizontally as shown to extend through the respective rail from an end of the rail to terminate at or near the center of the rail. One bar 116 extends from one footing of a rail and another bar 116 extends from the other footing, with both bars 116 meeting and being held flush against each other by a pin 118 in the center of the rail intermediate the footings. Each bar 116 may be supported at its end near the footing by a bushing 120 as shown.

In accordance with present principles, the ends of the bars 116 that are held together by the pin 118 are disposed on a weight sensor 122 that may be implemented by any of the above-discussed strain gages and other sensors. The skilled artisan will readily appreciate that weight on the footings 112 of a rail is transferred through the bars 116 to the weight sensor 122.

In turn, the weight sensor 122 may be mounted on a first circuit board 124 that in turn can be mounted on a second circuit board 126, it being understood that greater or fewer circuit boards can be used and that entire structure shown in FIG. 8 is mounted on the rails of a pad. The circuit board 124/126 supports one of the above-disclosed transmitters, e.g., the transmitter 26 along with necessary power sources (e.g., the battery 28) and control circuitry (e.g., the processor 24) electrically connected to the weight sensors 122 of the pad 100. The control circuitry can simply add the weight sensed by each sensor 122 to arrive at a total weight and then cause a signal representing the weight to be transmitted wirelessly to the receiver 30 shown in FIG. 1 for display thereof in accordance with above principles.

With the above low profile structure in which the weight sensing structure is not below the mat 101 but rather to the side, the mat 101 can be very close to the ground with a resulting shallow slope of the ramps 108, 110, making it easy for a caregiver to push a wheelchair with occupant onto the mat 101 to weigh the occupant. Further, with the footings placed outboard of the mat 101, undesirable tipping of the pad is eliminated. Further still, using the low power communication system disclosed in the referenced patents, the energy in the batteries in the pad 100 is conserved.

While the particular BATTERY POWERED MOBILITY SCALE WITH WIRELESS DISPLAY is herein shown and described in detail, it is to be understood that the subject matter which is encompassed by the present invention is limited only by the claims.

1. A scale system, comprising:
a base;
at least one weight sensor on the base to generate a signal representative of the weight of an object positioned on the base;
a processing system on the base and receiving signals from the weight sensor, the processing system generating a weight signal;
a wireless transmitter on the base and receiving the weight signal from the processing system;
at least one non-AC power source on the base and being the sole source of power for the processing system and transmitter;
a display module unconnected from the base and including an audible or visual display configured for displaying a weight; and
a wireless receiver on the display module and wirelessly receiving the weight signal from the wireless transmitter for display thereof on the display, the receiver being powered up to sample only once during a period such that the receiver has an energized duty circle of less than 55%.

2. The system of claim 1, comprising one or more non-AC power sources on the display module and being the sole source of power for the wireless receiver.

3. The system of claim 1, wherein the non-AC power source is at least one dc battery.

4. The system of claim 1, wherein the non-AC power source is a batteryless direct current power supply system including a capacitor powering the processing system and transmitter without the need for any other source of power.

5. The system of claim 1, wherein the base is established by at least one pad defining a mat for supporting a wheel, the mat being bounded by opposed raised rails, each rail being supported on the ground solely by opposed footings, each footing being coupled to a weight sensor in the rail.

6. The system of claim 5, wherein each rail has a respective weight sensor, and each footing of the rail is coupled to the weight sensor by a respective bar, the two bars of a rail being held together on the weight sensor.

7. The system of claim 5, wherein the pad is configured to support one and only one wheel.

8. The system of claim 5, wherein the pad is configured to support two tandem wheels.

9. The system of claim 5, wherein the pad is configured to support two side-by-side wheels.

10. A scale system, comprising:
a base on which an object to be weighed can be positioned;
means on the base for sensing a weight of the object;
means on the base for wirelessly transmitting a signal representative of the weight;
a display module distanced from the base;
means on the display module for receiving the signal representative of the weight; and
means on the display module for displaying the weight, wherein the base is established by at least one pad defining a mat for supporting a wheel, the mat being bounded by opposed elongated rails raised above the base, the pad being supported on the ground solely by opposed corner footings, each corner footing being disposed below the mat, each corner footing being coupled below the mat to a weight sensor.

11. The system of claim 10, comprising a processing system on the base and receiving signals from the means for sensing, at least one non-AC power source being on the base and being the sole source of power for the processing system and means for transmitting.

12. The system of claim 11, wherein the non-AC power source is at least one dc battery.

13. (canceled)

14. The system of claim 10, wherein each rail has a respective weight sensor, and each footing of the rail is coupled to the weight sensor by a respective bar, the two bars of a rail being held together on the weight sensor.

15. The system of claim 10, wherein the pad is configured to support one and only one wheel.

16. The system of claim 10, wherein the pad is configured to support two tandem wheels.

17. The system of claim 10, wherein the pad is configured to support two side-by-side wheels.

18. A method for weighing a user, comprising:
providing a base on a floor;
mounting a display module at a location spaced from the base;
generating a signal representative of a user's weight when the user stands on the base;
communicating a signal representative of the weight to the display module;
displaying the weight on the display module; and
wherein the signal representative of a user's weight is generated with weight sensors in opposed rails bounding a surface on which at least one wheel can be positioned, each weight sensor being coupled to opposed footings of a rail by at least one bar.

19. The method of claim 18, comprising powering all electrical components in the base using only a battery-based power supply.

20. (canceled)
